(19) United States
(12) Patent Application Publication
(10) Pub. No.: US 2005/0152428 A1
(43) Pub. Date: Jul. 14, 2005

(54) External-cavity laser tuned by physically-deformable distributed Bragg reflector

(76) Inventors: Annette C. Grot, Cupertino, CA (US); Ian Hardcastle, Sunnyvale, CA (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/754,780

(22) Filed: Jan. 9, 2004

(51) Int. Cl. H01S 3/08; H01S 3/082

(52) U.S. Cl. 372/92

(57) ABSTRACT

The external cavity laser includes a resonant cavity defined at one end by a Bragg reflector and a gain medium located in the optical cavity. Coupled to the Bragg reflector is an actuator that changes the pitch of the Bragg reflector and, hence, the wavelength at which the optical cavity is resonant. The wavelength of the light generated by the external cavity laser can therefore be tuned by a single control signal applied to the actuator.

### BACKGROUND OF THE INVENTION

Many optical instruments and communications systems include a tunable laser. In many applications, the wavelength range over which the tunable laser is tuned is about one hundred nanometers (nm) with a center wavelength of 1550nm, i.e., a tuning range of about ±3.5% about the center wavelength. For example, the model 83453A heterodyne optical spectrum analyzer recently introduced by Agilent Technologies, Inc. incorporates such a tunable laser.

Most conventional tunable lasers cannot be easily tuned over a wavelength range as wide as plus or minus a few percent of the center wavelength. The few conventional lasers that are capable of being tuned over a wide wavelength range have multiple control parameters that have to be varied to effect the tuning. Such control complexity is undesirable. Moreover, such tunable lasers are very expensive.

Thus, what is needed is a tunable laser that can be tuned over a wavelength range of several percent of a center wavelength using a single tuning parameter. What is also needed is a tunable external-cavity laser that is smaller and less expensive that currently-available tunable external-cavity lasers.

### SUMMARY OF THE INVENTION

The invention provides an external cavity laser that includes a resonant cavity defined at one end by a Bragg reflector and a gain medium located in the optical cavity. Coupled to the Bragg reflector is an actuator that changes the pitch of the Bragg reflector and, hence, the wavelength at which the optical cavity is resonant.

The wavelength of the light generated by the external cavity laser can therefore be tuned by a single control signal applied to the actuator.

### BRIEF DESCRIPTION OF THE DRAWINGS

FIG. 1 is a schematic diagram of a first embodiment of an external cavity laser in accordance with the invention.

FIG. 2 is a schematic diagram of a second embodiment of an external cavity laser in accordance with the invention.

FIG. 3 is a schematic diagram of a third embodiment of an external cavity laser in accordance with the invention.

FIG. 4 is a schematic diagram of a fourth embodiment of an external cavity laser in accordance with the invention.

FIG. 5 is a schematic diagram of a fifth embodiment of an external cavity laser in accordance with the invention.

FIG. 6 is a schematic diagram of a sixth embodiment of an external cavity laser in accordance with the invention.

### DETAILED DESCRIPTION OF THE INVENTION

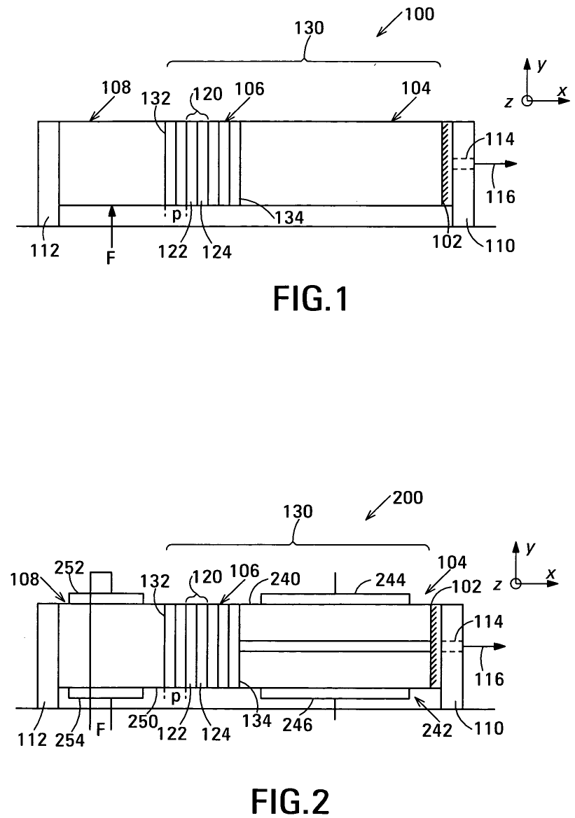

FIG. 1 shows a first embodiment 100 of a tunable external-cavity laser in accordance with the invention. Laser 100 is composed of a reflective element 102, an optical gain element 104, a distributed Bragg reflector 106 and an actuator 108. The reflective element, the optical gain element, the Bragg reflector and the actuator are arranged in order between fixed supports 110 and 112. Support 110 defines an aperture 114 through which light 116 generated by laser 100 is output.

Bragg reflector 106 is composed of a number of layer pairs arrayed in the x-direction shown. An exemplary layer pair is shown at 120. The reference numeral 120 will also be used to refer to the layer pairs collectively. Layer pair 120 is composed of layers 122 and 124 that differ in refractive index from one another. For light generated by optical gain medium 104 and incident on the Bragg reflector, the Bragg reflector has a wavelength-dependent reflectivity that has peaks at wavelengths λthat satisfy the following equations:
λ=4n₁t₁/a, and
λ=4n₂t₂/b,
where nᵢ and tᵢ are the refractive index and thickness, respectively, of layer 122 or 124 and a and b are odd integers. The combined thickness t₁+t₂ of the layers constituting the layer pairs will be referred to as the pitch p of the Bragg reflector.

Reflective element 102 and Bragg reflector 106 are located on opposite sides of optical gain element 104 and collectively define opposite ends of optical cavity 130. The optical cavity constitutes the external cavity of tunable external-cavity laser 100. The optical cavity has resonances at wavelengths that are an integral fraction of the optical path length of the optical path that extends through the optical gain element between reflective element 102 and Bragg reflector 106. The optical path length of an optical path is the sum of product of the physical path length and the refractive index for each element of differing refractive index in the optical path. In the illustrated embodiment, in which the optical path extends through a single material, i.e., that of optical gain element 104, the optical path length is simply the product of the physical length of the optical path through the optical gain element and the refractive index of the material of the optical gain element.

As noted above, Bragg reflector 106 has a reflectivity that is highly wavelength-dependent. The Bragg reflector is structured to have its maximum reflectivity at a wavelength that coincides with one of the wavelengths at which optical cavity 130 is resonant. The reflectivity of the Bragg reflector at other wavelengths at which the optical cavity is resonant is substantially lower than the maximum. As a result, the laser 100 generates light only at the wavelength at which the reflectivity of the Bragg reflector is a maximum.

Bragg reflector 106 is composed of alternating layers of materials of different refractive indices. At least one of the materials of the Bragg reflector is a compliant material that has a substantially lower Young's modulus than the material of optical gain element 104. Applying a compressive or tensile stress to the Bragg reflector decreases or increases, respectively, the thickness of the layers of the compliant material and, hence, the pitch p of the Bragg reflector. The decrease or increase in the pitch of the Bragg reflector decreases or increases, respectively, the wavelength at which the reflectivity of the Bragg reflector is a maximum.

Optical gain element 104, Bragg reflector 106 and actuator 108 are sandwiched between fixed supports 110 and 112. The actuator operates in response to the control signal F to apply force in the x-direction to the surface 132 of Bragg reflector 106. The position of the surface 134 of the Bragg reflector remote from surface 132 is defined by the optical gain element. Thus, the force applied to the Bragg reflector by the actuator determines the pitch p of the layer pairs constituting the Bragg reflector and, hence, the wavelength at which the reflectivity of the Bragg reflector is a maximum.

With the control signal F of a first level applied to actuator 108, the actuator applies a minimum force to Bragg reflector 106, and the pitch p of the layer pairs 120 constituting the Bragg reflector is a maximum p₀. The wavelength of the light generated by the laser 100 is therefore a maximum wavelength λ₀.

With the control signal F of a second level applied to actuator 108, the actuator applies a force greater than the minimum force to Bragg reflector 106. The force compresses the Bragg reflector and the surface 132 of the Bragg reflector moves in the +x-direction. Movement of surface 132 reduces the pitch p of the layer pairs 120 constituting the Bragg reflector relative to the maximum pitch p₀. This decreases the wavelength at which the reflectivity of the Bragg reflector is a maximum. As a result, tunable external-cavity laser 100 generates light with a wavelength shorter than the maximum wavelength λ₀. Further increases in the level of the control signal further reduce the pitch of the layer pairs and, hence, the wavelength of the light generated by tunable external-cavity laser 100.

Thus, tunable external-cavity laser 100 is tunable over a wavelength range using only a single control parameter, namely, the level of the control signal F applied to actuator 108.

FIG. 2 shows a practical embodiment 200 of a tunable external-cavity laser in accordance with the invention in which a semiconductor gain element is used as the optical gain element 104 and a piezoelectric chip is used as actuator 108. Elements of tunable external-cavity laser 200 that correspond to elements of tunable laser 100 described above with reference to FIG. 1 are indicated using the same reference numerals and will not be described again here.

Optical gain element 104 is composed of a semiconductor gain element 240. The semiconductor gain element is composed of a p-i-n semiconductor diode structure 242 through which current is passed via electrodes 244 and 246. In an embodiment, the semiconductor gain element has one or more quantum wells located in its intrinsic (i) region. The semiconductor gain element may additionally include juxtaposed elements of different refractive indices that define a waveguide structure that directs the light generated by the semiconductor gain element towards reflective element 102 and Bragg reflector 106. Semiconductor gain elements suitable for use as the optical gain element are known in the art and so will not be described further here. Other types of optical gain elements, such as an optically-pumped optical gain element or a gas-based optical gain element may alternatively be used.

Actuator 108 is composed of a piezoelectric chip 250 having electrodes 252 and 254 located on opposite surfaces. In an embodiment, the electrodes are deposited on opposite surfaces of the piezoelectric chip. Control signal F is an electrical signal applied between the electrodes. The electrodes are arranged such that a first polarity of the control signal F causes the piezoelectric chip to expand in the x-direction.

Tunable external-cavity laser 100 described above with reference to FIG. 1 generates light at the maximum wavelength λ₀ when the level of the control signal F is zero. Applying control signal F of a first polarity and with a level different from zero causes laser 100 to generate light at a wavelength shorter than λ₀. In tunable external-cavity laser 200, a second polarity of control signal F, opposite to the first polarity, will cause piezoelectric chip 250 to contract in the x-direction and move surface 132 in the x-direction.

The tuning range of tunable external-cavity laser 200 may be increased by subjecting Bragg reflector 106 to a compressive stress during assembly of the laser. With a zero-level control signal applied to the piezoelectric chip, the tunable external-cavity laser generates light with a wavelength λ_{M}, which is approximately the mid-point of its tuning range. Applying control signal F with the first polarity to piezoelectric chip 250 will cause the piezoelectric chip to expand. This increases the compressive stress applied to the Bragg reflector 106, which reduces the pitch of the Bragg reflector and the decreases the wavelength of the light generated. Applying the control signal F with the second polarity to the piezoelectric chip will cause the piezoelectric chip to contract. This decreases the compressive stress applied to Bragg reflector 106, which increases the pitch of the Bragg reflector and the wavelength of the light generated. Thus, laser 200 can be tuned to wavelengths both longer than and shorter than the wavelength corresponding to the zero level of the control signal F. The compressive stress applied to the Bragg reflector during assembly should be greater than the compressive stress relieved by the maximum contraction of the piezoelectric chip by a suitable safety margin. This way, the Bragg reflector is subject to a small amount of compressive stress with the piezoelectric chip in its state of maximum contraction.

An increased tuning range may alternatively be obtained by bonding one end of actuator 108 to the surface 132 of Bragg reflector 106 and the other end of the actuator to fixed support 112. Additionally, one end of optical gain element 104 is bonded to the surface 134 of Bragg reflector and the other end of the optical gain element is bonded to one end of reflective element 102. Finally, the other end of the reflective element is bonded to fixed support 110. Control signal F of the second polarity causes the actuator to contract, as described above. The actuator in its contracted state applies a tensile stress to the Bragg reflector, which increases the pitch of the Bragg reflector and the wavelength of the light generated by tunable external-cavity laser 200.

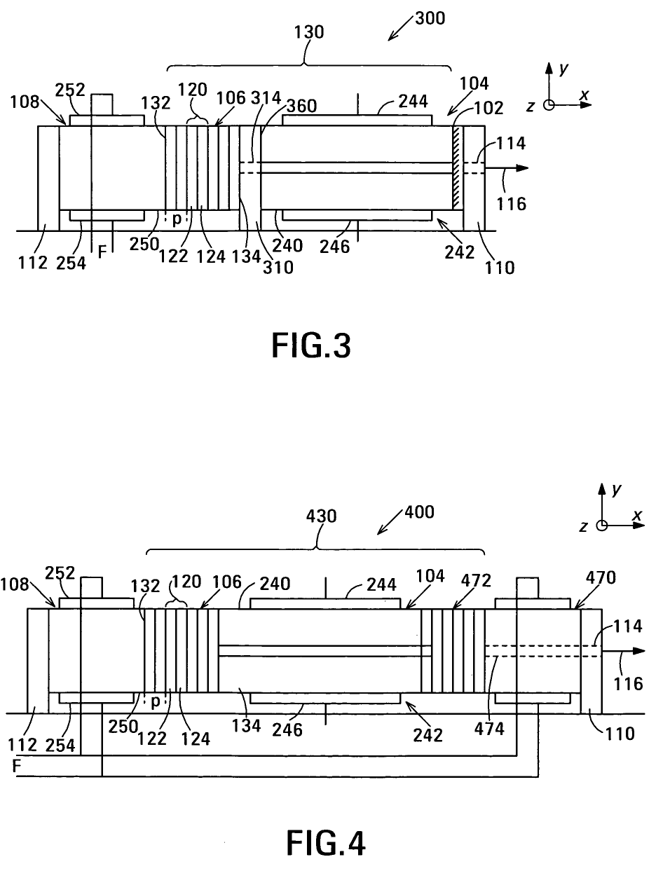

FIG. 3 shows a third embodiment 300 of a tunable external-cavity laser in accordance with the invention in which the optical gain element is isolated from the force applied to the Bragg reflector by the actuator. Elements of tunable external-cavity laser 300 that correspond to elements of the tunable external cavity lasers described above with reference to FIGS. 1 and 2 are indicated using the same reference numerals and will not be described again here.

In laser 300, fixed support 310 is interposed between the surface 134 of Bragg reflector 106 and the end of optical gain element 104 closer to the Bragg reflector. In the example shown, optical gain element is a semiconductor gain element 240 similar to that described above. Fixed support 310 defines an aperture 314 through which light passes to and fro between optical gain element 104 and Bragg reflector 106. Support 310 isolates the optical gain element from the force applied to the Bragg reflector by the actuator. The support has a substantially lower compliance than the optical gain element. This further simplifies the relationship between the expansion and/or contraction of actuator 108 and the resulting change in the pitch of Bragg reflector 106. The expansion and/or contraction of actuator is proportional to the force applied by the actuator divided by the effective Young's modulus of the Bragg reflector.

FIG. 4 shows a fourth embodiment 400 of a tunable external-cavity laser in accordance with the invention in which the optical cavity is bounded at both ends by a Bragg reflector and an actuator. Elements of tunable external-cavity laser 400 that correspond to elements of the tunable external cavity lasers described above with reference to FIGS. 1, 2 and 3 are indicated using the same reference numerals and will not be described again here.

Laser 400 is composed of an actuator 470, a Bragg reflector 472, optical gain element 104, Bragg reflector 106 and actuator 108. Actuator 470, Bragg reflector 472, the optical gain element, Bragg reflector 106 and actuator 108 are arranged in order between fixed supports 110 and 112. Optical cavity 430 extends from Bragg reflector 106 to Bragg reflector 472.

Similar to Bragg reflector 106, Bragg reflector 472 is composed of layer pairs arrayed in the x-direction. However, Bragg reflector 472 is composed of fewer layer pairs than Bragg reflector 106 to enable laser 400 to emit light 106 through Bragg reflector 472.

Actuator 470 is similar to actuator 108, except that it defines an aperture 474 through which light 116 generated by laser 400 is output. Actuator 108 may additionally define an aperture (not shown) to enable the same component to be used as either actuator.

In the example shown, semiconductor gain element 240 is used as optical gain element 104 and piezoelectric chips, e.g., piezoelectric chip 250 with electrodes, e.g., electrodes 252 and 254, applied to their opposed surfaces are used as actuators 106 and 470. In the example shown, control signal F is applied the electrodes of both actuators. Alternatively, each actuator may receive a different control signal.

In another embodiment, actuator 470 is omitted and Bragg reflector 472 abuts fixed support 110.

Additional fixed supports (not shown) may be interposed between optical gain element 104 and each of Bragg reflectors 106 and 472 in a manner similar to fixed support 310 described above with reference to FIG. 3. Such additional fixed supports isolate the optical gain medium from the forces applied by actuators 108 and 470 to Bragg reflectors 106 and 472, respectively. Such additional fixed support allow Bragg reflectors 106 and 472 to be differently expanded or compressed by their respective actuators 108 and 470.

In the above embodiments, in addition to or instead of the piezoelectric chips exemplified, various types of electromagnetic, electrostatic, thermal, hydraulic, pneumatic or other transducers may be used as either or both of actuator 108 and actuator 472. Such other type of actuator is operable to change the pitch of the respective Bragg reflector by either or both of expanding or compressing the Bragg reflector as described above. For example, a MEMs-based actuator driven by an electrostatic stepper motor could be used. Moreover, instead of acting directly on the respective Bragg reflectors as exemplified above, such piezoelectric and other actuators may be coupled to their respective Bragg reflectors by mechanical linkage (not shown). Such mechanical linkage may be configured to increase the mechanical force or the range of movement applied to the Bragg reflectors by the respective actuator.

In the tunable lasers described above, the Bragg reflector 106 is composed of layer pairs 120 and one additional layer so that the total number of layers constituting the Bragg reflector is an odd number. Each layer pair is composed of a layer of a first material having a lower refractive index and a layer of a second material having a higher refractive index. The additional layer is a layer of the first material. At least one of the materials of the Bragg reflector has a Young's modulus substantially less than that of the optical gain element 104 or the support 310 to enable stress applied to the Bragg reflector by the actuator 108 to change the pitch p of the Bragg reflector.

In one embodiment, Bragg reflector 106 is composed of an odd number of layers of the first material having a relatively low refractive index alternating with an even number of layers of the second material having a relatively high refractive index. Additionally, the first material has a relatively low Young's modulus and the second material has a relatively high Young's modulus. In response to compressive stress applied by actuator 108, the dimension of the layers of the second material in the x-direction remains substantially unchanged, and most of the change in the pitch of the Bragg reflector is provided by a change in the dimension of the layers of the first material in the x-direction. The dimension of the layers in the x-direction will be referred to as the thickness of the layers.

In an example of such an embodiment, a photopolymer is used as the first material. Certain polymers undergo cross-linking when exposed to high intensities of light in the presence of an initator. Exemplary polymers include PMMA, epoxy and polyimide. Many ultraviolet (UV)-light initiators are suitable for use as initiators with these polymers including, for example, Ciba® IGRACURE® 184 and 819 photoinitiators sold by Ciba Specialty Chemicals Additives of Tarrytown, N.Y. Examples of commercially-available pre-mixed polymers and UV initiators are Type J91 optical cement sold by Summers Optical of Fort Washington, Pa. and Type NOA 61 optical adhesive sold by Norland Products, Inc. of Cranbury N.J. The Young's modulus of the cured photopolymer depends on the amount of cross-linking. The cross-linking depends on the UV exposure. Thus, the UV exposure is controlled to determine the Young's modulus of the cured material.

Examples of materials suitable for use as the second material include acrylic, polyester, polyimide, polycarbonate and polytetrafluorethylene AF.

Bragg reflector 106 is fabricated by depositing alternate layers of the first and second materials. The layers, which are of the order of 250 nm thick for a laser structured to generate light at a center wavelength of about 1550 nm, are deposited by spin coating. Some materials may be deposited by chemical vapor deposition, inking/stamping or dip coating. Each layer of photopolymer first material is cured by exposing it to UV light, as described above, after it is deposited. The number of layer constituting Bragg reflector 106 depends on the refractive index contrast between the first and second materials. As few as three layers (1.5 layer pairs) can be used when the first and second materials have a large refractive index contrast.

In another embodiment, Bragg reflector 106 is composed of an odd number of layers of the first material having a relatively low refractive index alternating with an even number of layers of the second material having a relatively high refractive index. In this embodiment, the first material and the second material have Young's moduli that are low compared with that of optical gain element 104 or support 310. In response to a compressive stress applied by actuator 108, the layers of the first material and the second material change similarly in thickness to the change in the pitch of the Bragg reflector. To maintain the appropriate relative thicknesses of the layers as the pitch of the Bragg reflector changes, the first and second materials should have respective Young's moduli that are proportional to the thicknesses of the layers. In other words, the Young's modulus of the first material of the thicker, low-index layers should be proportionally greater than the Young's modulus of the second material of the thinner, high-index layers so that the thickness ratio of the layers is maintained as stress is applied to the Bragg reflector.

In exemplary embodiment, one of the photopolymers described above is used as both the first material and the second material. The photopolymer constituting the first material is subject to less UV exposure during curing that the photopolymer constituting the second material.

In another embodiment, the first, low refractive index material has a relatively high Young's modulus and the second, high refractive material has a relatively low Young's modulus. In an example, the first material is polystyrene and the second material is acrylic. In another example, the first material is a compliant, low refractive index material such as polydimethylsiloxane (PDMS) infiltrated with a high refractive index material such as titanium dioxide (TiO₂), and the second material is acrylic.

Bragg reflector 474 shown in FIG. 4 is similar to Bragg reflector 106 and will not be separately described.

In the embodiments described above, optical gain element 104 is fabricated of materials having a substantially greater Young's modulus than that of at least the first material of Bragg reflector 106. As a result, the length of optical cavity 130 remains substantially unchanged as the laser is tuned. The unchanging length of the optical cavity subjects the laser to mode hopping. While mode hopping may be tolerable in applications in which the laser spends most or all of its time generating light at the fixed wavelength to which it has been tuned, mode hopping is undesirable in applications in which the wavelength of the laser is swept over a range of wavelengths or in applications in which the laser is tuned to a wavelength at which the dominant mode can change.

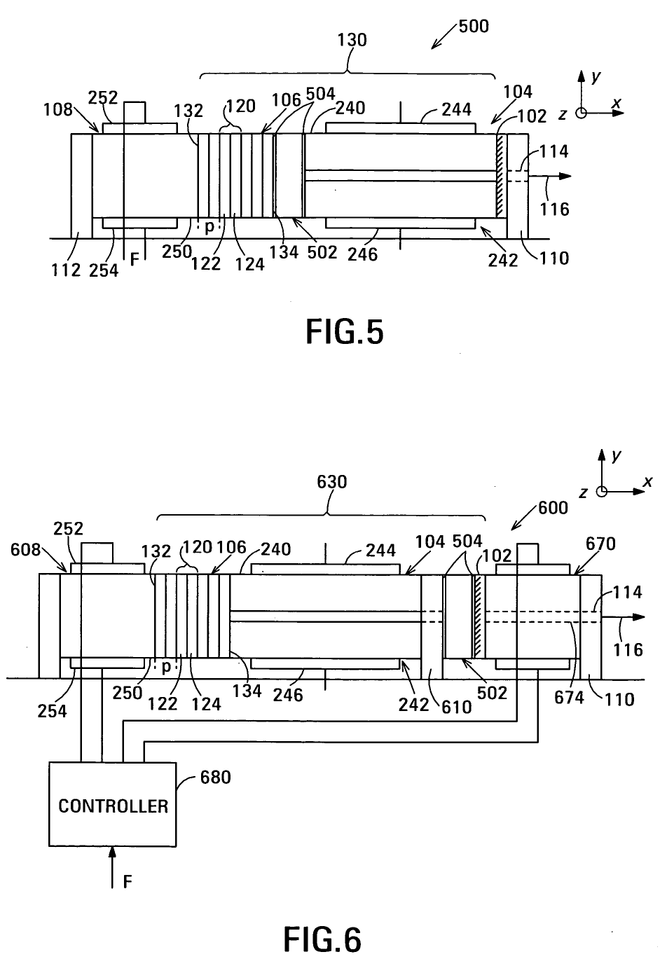

FIG. 5 shows an exemplary embodiment 500 of a tunable external-cavity laser in which the actuator additionally changes the optical path length of the optical cavity to maintain the laser in a constant mode as the laser is tuned. Elements of tunable external-cavity laser 500 that correspond to elements of the tunable lasers described above with reference to FIGS. 1 and 2 are indicated using the same reference numerals and will not be described again here.

Laser 500 is additionally composed of a mode control element 502 located in optical cavity 130 between Bragg reflector 106 and reflector 102. In the example shown, the mode control element is shown located between Bragg reflector 106 and optical gain element 104. The mode control element may alternatively be located between the optical gain element and reflector 102. Stress generated by actuator 108 is coupled to mode control element 502 by Bragg reflector 106.

Mode control element 502 is a layer of material that is transparent in the wavelength range in which laser 500 generates light. The material of the mode control element has a Young's modulus substantially less than that of optical gain element 104. Stress applied by actuator 108 to Bragg reflector 106 is also applied to the mode control element, and changes the size of the mode control element in the x-direction in addition to changing as the pitch of the Bragg reflector. The size of the mode control element in the x-direction will be referred to as the thickness of the mode control element. The thickness of the mode control element depends on the Young's modulus of the material of the mode control element and the thickness and Young's modulus of the layers of the Bragg reflector. The mode control element has a thickness such that, as laser 500 is tuned, the stress applied by actuator 108 produces a strain in the mode control element that maintains a constant ratio between the optical path length of optical cavity 130 and the wavelength at which Bragg reflector has peak reflectivity. With this relationship, strain in the mode control element changes the length of optical cavity 130 in accordance with the change in the pitch of the Bragg reflector to maintain the mode of the laser.

Mode control element 502 may be fabricated using one or more of the materials from which Bragg reflector 106 is fabricated. Other elastic, optically transparent materials can alternatively be used. In an embodiment, the mode control element is fabricated of the first material of the Bragg reflector. This is the same material as that of the adjacent layer of the Bragg reflector. Using the same material reduces reflection of light at the interface between the mode control element and the Bragg reflector.

In another embodiment, one of the outer layers of Bragg reflector 106 has an increased thickness and provides mode control element 502.

FIG. 5 shows the optional anti-reflective layers 504 on opposite sides of mode control element 502. The anti-reflective layers reduce reflections at the interfaces between the mode control element and the Bragg reflector and between the mode control element and optical gain element 104. In other embodiments, one or both anti-reflective layers are omitted.

Maintaining the mode of laser 500 requires that the thickness of mode control element 502 track the pitch of Bragg reflector 106 as the pitch of the Bragg reflector and the thickness of the mode control element change in response to stress applied by actuator 108. Since the actuator applies the same stress to the mode control element and the Bragg reflector, an appropriate choice of the materials of the Bragg reflector and the mode control element has to be made to enable the tracking condition to be met.

FIG. 6 shows an embodiment 600 of a tunable external-cavity laser in accordance with the invention that allows a substantially greater freedom of choice in the materials of the Bragg reflector and the mode control element. In laser 600, independent actuators apply stress to the Bragg reflector and to the mode control element in respective control signals. The control signals are configured to maintain tracking between the pitch of the Bragg reflector and the thickness of the mode control element. Elements of tunable external-cavity laser 600 that correspond to elements of the lasers described above with reference to FIGS. 1, 2 and 5 are indicated using the same reference numerals and will not be described again here.

Unlike the lasers described above, laser 600 has two independent actuators, namely, a tuning actuator 608 and a mode control actuator 670. Tuning actuator is located between Bragg reflector 106 and support 112. Mode control actuator 670 is located between mode control element 502 and support 110. Mode control element 502 is located in optical cavity 630 between optical gain element 104 and reflector 102. Stress from mode control actuator 670 is coupled to mode control element 502 by reflector 102.

Laser 600 additionally includes a support 610 located between reflector 102 and optical gain element 104. Support 610 mechanically isolates Bragg reflector 106 and tuning actuator 608 from mode control element 500 and mode control actuator 670. This enables the tuning actuator to apply to the Bragg reflector stress that is independent of the stress applied by the mode control actuator to the mode control element.

In the example shown, actuators 608 and 670 are similar in structure to the exemplary embodiment of actuator 108 described above with reference to FIG. 2. Actuator 670 defines an aperture 674 and support 614 defines an aperture 614 through which light generated by laser 600 passes.

Laser 600 additionally includes a controller 680 that receives wavelength control signal F. The controller is structured to generate in response to the wavelength control signal a tuning control signal that is applied to tuning actuator 608 and a mode control signal that is applied to mode control element 670. The wavelength control signal defines the wavelength at which laser 600 is to generate light. In response to the wavelength control signal, the controller generates the tuning control signal that, when applied to the tuning actuator 608, causes the tuning actuator to apply to Bragg reflector 106 a stress that sets the Bragg reflector to a pitch that gives the Bragg reflector a maximum reflectivity at the wavelength defined by the wavelength control signal. Additionally, in response to the wavelength control signal or the tuning control signal, the controller generates the mode control signal that, when applied to the mode control actuator 670, causes the mode control actuator to apply to mode control element 502 a stress that sets the mode control element to a thickness that maintains the mode of laser 600 at the wavelength defined by the wavelength control signal.

The above-mentioned tracking between the pitch of Bragg reflector 106 and the thickness of mode control element 500 is established by controller 680 applying the mode control signal to mode control actuator 670 and the tuning control signal to tuning actuator 608 with the appropriate level relationship between the control signals.

In an exemplary embodiment, controller 680 calculates the tuning control signal from the wavelength control signal and the mechanical and optical properties of Bragg reflector 106 and the electromechanical properties of tuning actuator 608. The controller additionally calculates the mode control signal from the wavelength control signal or the tuning control signal, the mechanical and optical properties of optical cavity 630 and mode control element 502 and the electromechanical properties of mode control actuator 670. Circuits or computational elements capable of performing such calculations are known in the art and will therefore not be described here. In a variation, the controller operates closed loop.

In another exemplary embodiment, tuning control signal values corresponding to different values of the wavelength control signal F are calculated in advance from the mechanical and optical properties of Bragg reflector 106 and the electromechanical properties of tuning actuator 608. Additionally, mode control signal values corresponding to the values of the wavelength control signal are calculated in advance from the mechanical and optical properties of optical cavity 630 and mode control element 502 and the electromechanical properties of mode control actuator 670. The calculated values of the tuning control signal and the mode control signal are then stored cross-referenced to the values of the wavelength control signal in a look-up table in controller 680. In response to a value of the wavelength control signal, corresponding values of the tuning control signal and the mode control signal are output from the look-up table and are fed from the controller tuning actuator 608 and mode control actuator 670, respectively. Look-up tables capable of outputting control signals from values of a wavelength control signal are known in the art and will therefore not be described here.

This disclosure describes the invention in detail using illustrative embodiments. However, the invention defined by the appended claims is not limited to the precise embodiments described.

1. An external cavity laser, comprising:
a resonant optical cavity defined at one end by a Bragg reflector;
an optical gain element located in the optical cavity; and
an actuator coupled to the Bragg reflector to change the pitch of the Bragg reflector and the wavelength at which the optical cavity is resonant.

2. The external cavity laser of claim 1, additionally comprising a reflective element defining the other end of the resonant optical cavity.

3. The external cavity laser of claim 1, additionally comprising a pair of fixed supports between which the reflective element, the optical gain medium, the Bragg reflector and the actuator are sandwiched.

4. The external cavity laser of claim 3, in which one of the fixed supports defines an aperture through which light is output from the laser.

5. The external cavity laser of claim 3, additionally comprising an additional fixed support interposed between the optical gain element and the Bragg reflector, the additional fixed support defining an aperture.

6. The external cavity laser of claim 3, in which the actuator comprises a piezoelectric chip.

7. The external cavity laser of claim 3, in which the optical gain element comprises a semiconductor gain element.

8. The external cavity laser of claim 1, in which the actuator comprises a piezoelectric chip.

9. The external cavity laser of claim 1, in which the optical gain element comprises a semiconductor gain element.

10. The external cavity laser of claim 1, additionally comprising an additional Bragg reflector defining the other end of the optical cavity.

11. The external cavity laser of claim 10, additionally comprising a pair of fixed supports between which the additional Bragg reflector, the optical gain medium, the Bragg reflector and the actuator are sandwiched.

12. The external cavity laser of claim 10, in which one of the fixed supports defines an aperture through which light is output from the laser.

13. The external cavity laser of claim 10, in which the actuator comprises a piezoelectric chip.

14. The external cavity laser of claim 10, in which the optical gain element comprises a semiconductor gain element.

15. The external cavity laser of claim 10, additionally comprising an additional actuator coupled to the additional Bragg reflector.

16. The external cavity laser of claim 1, additionally comprising a mode control element located in the optical cavity.

17. The external cavity laser of claim 16, in which the actuator is additionally coupled to the mode control element.

18. The external cavity laser of claim 16, additionally comprising an additional actuator coupled to the mode control element.

19. The external cavity laser of claim 18, additionally comprising:
a first fixed support and a second fixed support between which the actuator, the Bragg reflector and the optical gain medium are sandwiched, and
a third fixed support, the mode control element, the reflector and the additional actuator being sandwiched between the second fixed support and the third fixed support.

20. The external cavity laser of claim 18, additionally comprising a controller structured to deliver control signals to the actuator and the additional actuator that maintain the laser in a constant mode as the laser is tuned.
